(19) United States
(12) Patent Application Publication
(10) Pub. No.: US 2013/0075353 A1
(43) Pub. Date: Mar. 28, 2013

(54) Foldable Lifting Apparatus

(71) Applicant: Scott Thompson, Hettinger, ND (US)

(72) Inventor: Scott Thompson, Hettinger, ND (US)

(21) Appl. No.: 13/246,313

(22) Filed: Sep. 27, 2011

(51) Int. Cl. B66C 23/44; F16M 13/00; B66C 23/42

(52) U.S. Cl. 212/180; 212/295; 248/351; 212/270

(57) ABSTRACT

The present invention is a self-locking folding crane apparatus that can be left on a vehicle or cart while it is in either an operative or stowed state. Unlike all other portable cranes that were found in prior art either singly or in combination, the present invention requires no assembly or disassembly between uses.

### CROSS REFERENCE TO RELATED APPLICATIONS

None

### STATEMENT REGARDING FEDERALLY SPONSORED RESEARCH

None

### FIELD OF THE INVENTION

The present invention relates to the field of cranes, hoists, and lifting devices.

### BACKGROUND OF THE INVENTION

This invention teaches improvements to portable hoists that are mountable to vehicles, building structures, carts, trailers, and the like. Examples in prior art are abundant and include teachings by Harr and Cary who introduce portable cranes in U.S. Pat. Nos. 5,752,799 and 5,993,137. Kruse teaches a in U.S. Pat. No. 6,007,289 that mounts into a receiver hitch and uses a jig to stabilize and increase the lifting capability of a hoist that is designed for powered mobility chairs. Williams teaches a portable mobility chair crane in U.S. Pat. No. 6,830,423 that engages a vehicle receiver adapter. Robinette teaches a low-pivot-point lift in U.S. Pat. No. 5,211,526 that does not have a hinge point.

Spitsburgen teaches a portable lift in U.S. Pat. No. 6,499,610 for medium to heavy applications. The '610 apparatus is readily assembled before each use and can be disassembled after use for easy storage. The Spitsburgen lift is mountable to vehicles, equipment, trailers, and building structures. Griffith teaches recoverable installation of a hitch hoist that is suitable for heavier objects in Canadian Patent 2,108,107. Davis teaches a multi-purpose hoist in U.S. Pat. No. 5,749,697 with top and bottom components mate together during assembly. Likewise Barger teaches a portable crane in U.S. patent application Ser. No. 10/657,029 that is adaptable to shop work benches, vehicles, and other stable structures. Amato teaches a swingable boom-type portable crane in U.S. Pat. No. 4,881,864 that engages the receiver hitch of a vehicle.

Compton teaches a collapsible hoist in U.S. Pat. No. 6,152,675 that has a sufficiently high center mast to elevate hunting game; the hoist is assembled, installed, and subsequently removed between uses. A collapsible hoist taught by Perkins in U.S. Pat. No. 6,578,722 also engages a vehicle receiver hitch and has a telescoping mast that is able to achieve a sufficient height to raise tall objects. Phillip and Angel teach similar game hoists in U.S. Pat. Nos. 6,705,821 and 7,201,552.

Other exemplary embodiments are described in U.S. Pat. Nos. 6,478,528, 6,386,820, 5,520,498, 5,445,487, 5,014,863, 7,300,238, 6,981,834, 6,860,703, 6,138,991, 6,089,431, 6,082,561, 5,810,547, 5,788,095, 5,800,117, 5,662,451, 4,417,665 and US patent application publication 20110206488.

All examples and combinations of examples of portable cranes found in prior art rely on assembly before use and disassembly after use. Among the above listed examples, the '675, '522, '722 and '821 cranes share the additional common drawback that they do not pivot. US Patent Application US2009/0067968 A1 also teaches a portable crane that requires assembly between uses and does not pivot. Prior art is quick to point out that each phase of assembly can be performed in as little as 2 minutes.

The present invention unveils a notable improvement by teaching a hoist that unfolds into a usable state in as little as 2 seconds and folds into a stowed state just as quickly. No assembly is required to transition the present invention in an operable state and no disassembly is required to revert the present invention back into a stowed state. To achieve this improvement over prior art the present invention combines a low profile pivoting hinge with latching and stopping surfaces, a hinge mounted mast with latching and stopping surfaces, and a hinge mounted boom with latches and stopping surfaces that automatically lock the hoist into operable and stored states as it is folded or unfolded. Nothing found in prior art or any combination thereof is seen to describe the present invention.

### BRIEF SUMMARY OF THE INVENTION

This invention teaches improvements to portable hoists. The principal improvement over prior art is the capability to unfold into an operable state without additional steps to assemble or secure the hoist. Other improvements over prior art include knee-operable rotational load control, safety measures to enable the apparatus to remain assembled and engaged to a receiver hitch while in tow, a telescoping kick-stand style jig, the capability to fold into a stowed state without additional steps to disassemble or secure the hoist, and a pivoting hinge that is designed to engage the stanchion in a manner that improves lifting capacity and product safety.

### DESCRIPTION OF THE DRAWINGS

Further features, advantages, and benefits of this invention, as well as the structure and operation of various embodiments thereof, are described in detail below with reference to the accompanying drawings. In the drawings, like reference numbers generally indicate identical, functionally similar, and/or structurally similar elements. The drawing in which an element first appears is indicated by the leftmost digits in the corresponding reference number. The drawings disclosed herein are illustrative of preferred and sample embodiments of the disclosed invention and are not intended to limit the spirit or scope thereof.

FIG. 1 shows a preferred embodiment of the present invention.

FIG. 2 shows essential components of a preferred embodiment of the present invention.

FIG. 3 shows how mating surfaces are used to lock an embodiment of the present invention into an operable state.

FIG. 4 shows a boom latch that is used to lock the boom into an operable state.

FIG. 5 shows a boom that is adaptable for use with boom latch of the present invention.

FIG. 6 shows how the pivot shaft and pivoting hinge mate in a preferred embodiment of the present invention.

FIG. 7 shows a recoverable installable vehicle base mount that engages the pivot shaft of a preferred embodiment of the present invention.

FIG. 8 shows a portable base mount that engages the pivot shaft of a preferred embodiment of the present invention to form an engine hoist.

FIG. 9 shows a plurality of base mounts adaptable to the present invention that are installed on a trailer.

FIG. 10 shows a base mount adaptable to the present invention that is installed on a work table.

FIG. 11 shows a base mount that engages the pivot shaft of the present invention that adaptively installable onto a roof, floor, or wall.

FIG. 12 shows a latch that automatically engages the stanchion as it is folded into base mount of a preferred embodiment of the present invention.

FIG. 13 shows a latch that engages the boom as it is folded into the stanchion of a preferred embodiment of the present invention.

FIG. 14 shows an insert that engages the boom of a preferred embodiment of the present invention to form an extendable boom.

FIG. 15 shows a kickstand style jig that is mounted to a vehicle receiver hitch adapter of a preferred embodiment of the present invention.

FIG. 16 shows a hand-brake winch, a rotational swing lock, and a latch that is used to prevent a preferred embodiment of the present invention from unintentionally folding out of an operative state.

FIG. 17 shows an electric winch that is mounted to a preferred embodiment of the present invention in a stowed state.

FIG. 18 shows a preferred embodiment of the present invention that uses actuators to induce movement.

FIG. 19 shows a preferred embodiment of the present invention coupled to an all-terrain vehicle on the load side and to a receiver hitch at the mounting engagement point.

FIG. 20 shows a preferred embodiment of the present invention lifting an all-terrain vehicle into the back of a flat-bed truck.

FIG. 21 shows a preferred embodiment of the present invention hoisting an elk while a hunter process it.

FIG. 22 shows a preferred embodiment of the present invention leans over while lifting a log that is beyond the lifting capacity of the crane.

FIG. 23 shows a preferred embodiment of the present invention mounted to a sedan style vehicle.

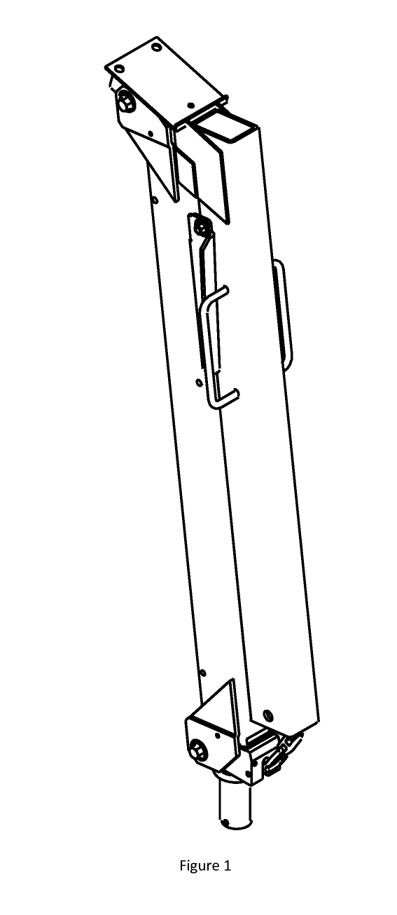

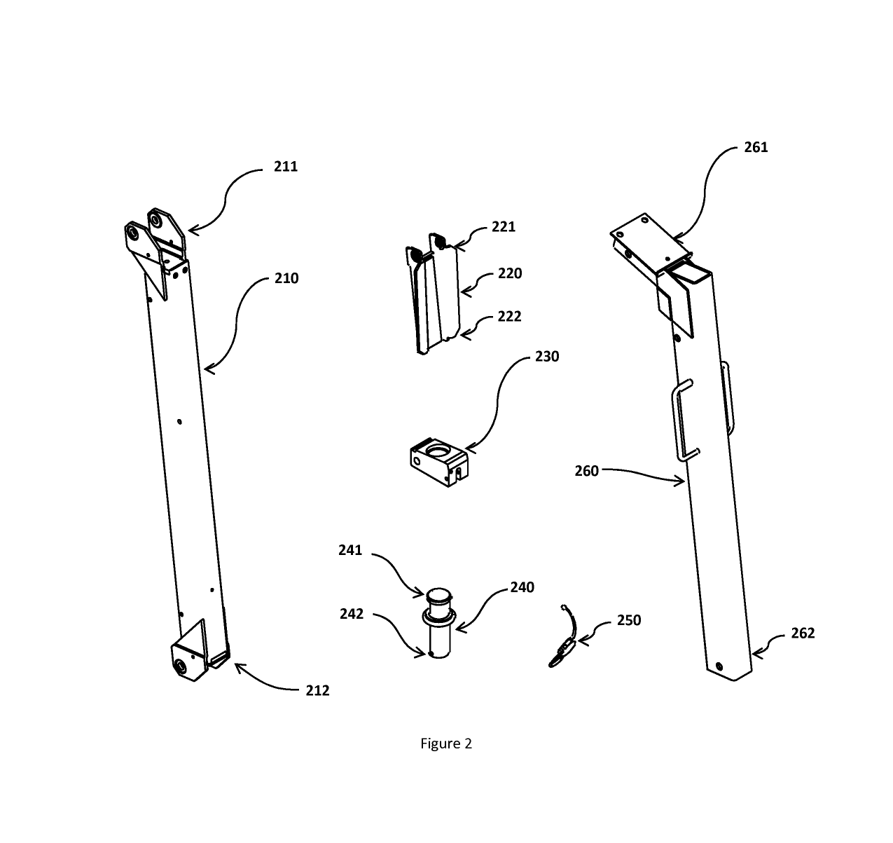

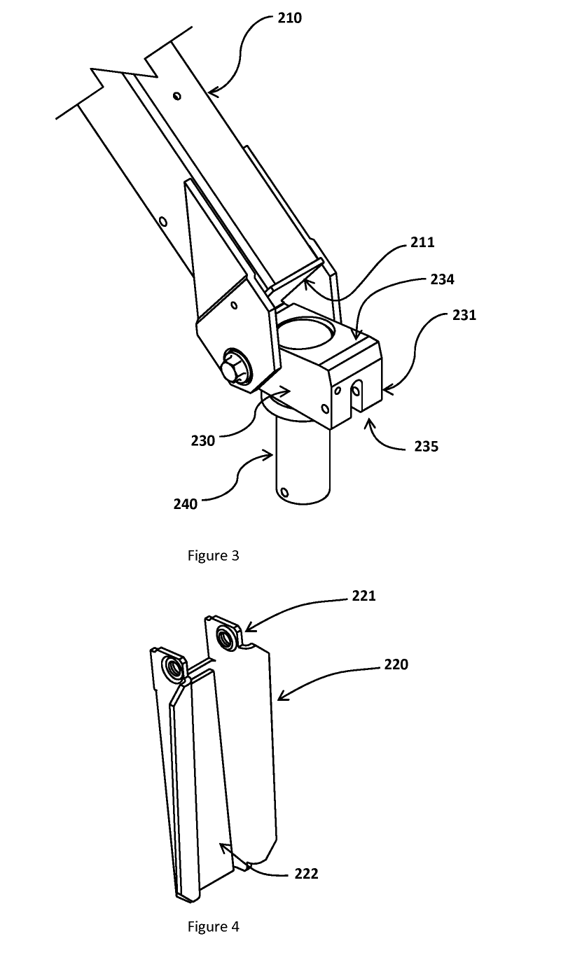

### DETAILED DESCRIPTION OF PREFERRED EMBODIMENTS

The present invention is a portable crane that is able to fold in and out of operative states without the need for assembly or disassembly between uses and is able to remain assembled while in tow. Essential components of this invention include a pivot shaft 240, boom latch 220, load coupler 250, and an assembly comprising a stanchion 210, pivot hinge assembly 230, and boom 260; all having locking surfaces automatically engage as the hoist is folded between operable and stowed states.

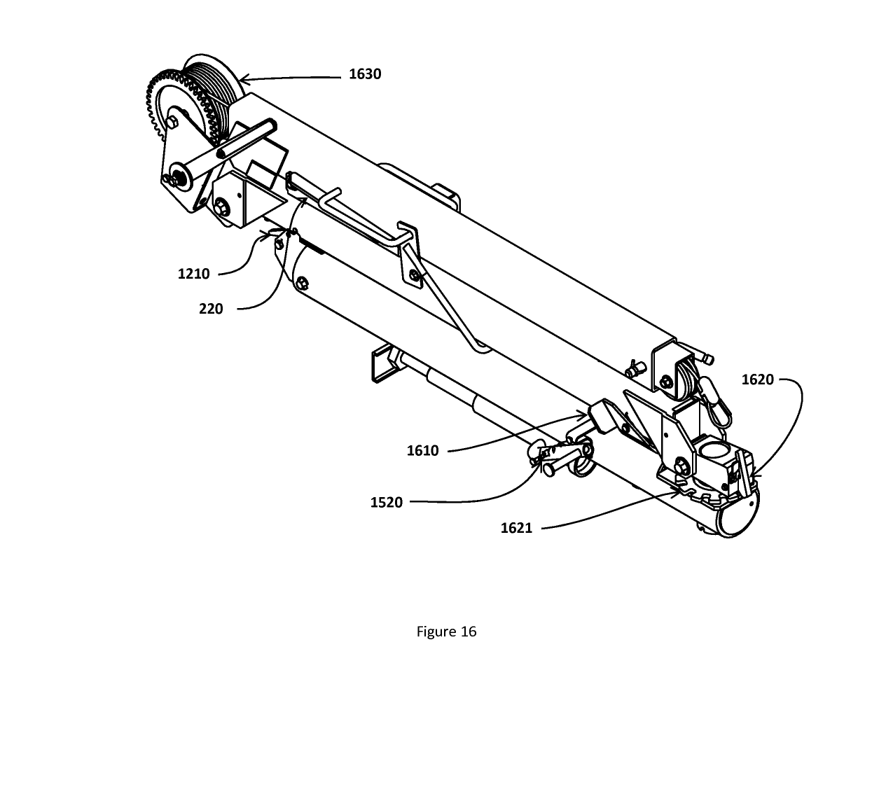

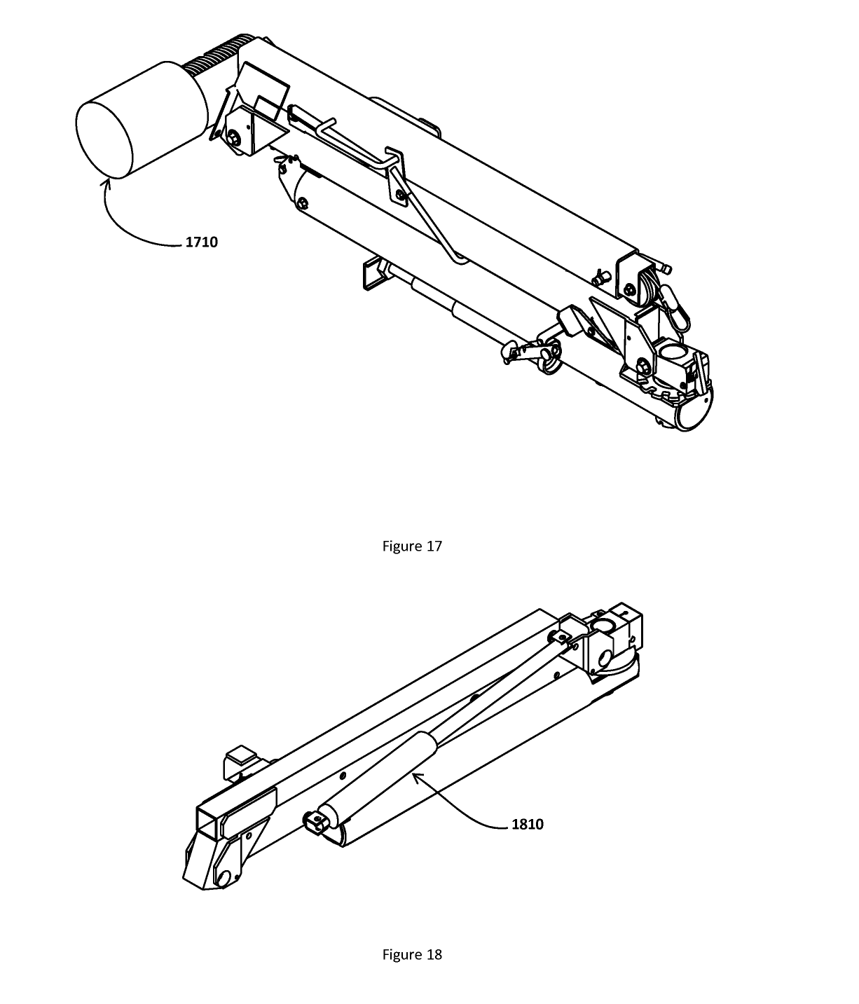

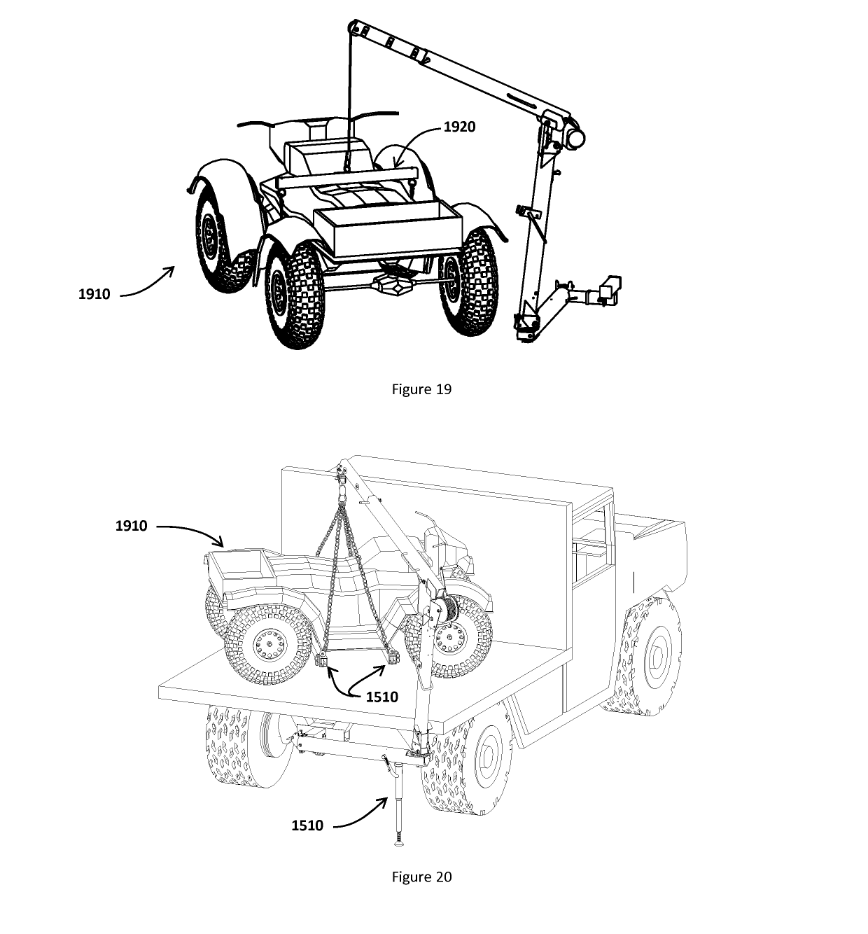

Embodiments of this invention are shown unfolded into an operative state in FIGS. 19 thru 22 in the drawings. The stanchion generally rests in a horizontal position when folded into a stowed state. Embodiments of this invention are shown folded into a stowed state in FIGS. 16 thru 18.

The term “stanchion” refers herein to a component of the hoist 210 that operates as a substantially vertical mast when the hoist is unfolded into an operable state. The stanchion 210 of the present invention has a locking surface at the distal end 211 that engages the upper surface of a pivot hinge 231 as the apparatus is unfolded. The stanchion 210 also has a locking surface at the proximal end 212 that engages the distal surface 221 of the boom lock. The pivot hinge 230 and the boom lock 220 are defined below.

The term “pivot hinge” refers herein to a component 230 that is hinge coupled to the base of the stanchion 210, has a substantially horizontal upper surface 234 that engages the locking surface at the distal end 211 of the stanchion as it is unfolded into a locked operative position. FIG. 3 shows how the pivot hinge 230 and the stanchion 210 are assembled and how the locking surfaces of each component mate as a preferred embodiment unfolds.

The term “pivot shaft” refers herein to a substantially cylindrical shaped shaft 240 that is rotationally coupled to a pivot hinge 230 and adaptively coupled to a receiver adapter 770. FIG. 6 shows how the pivot shaft is passed through the pivot hinge to form a rotationally coupled union between both components.

The term “boom” refers to a lifting arm 260 that is adaptively coupled to a load coupling device 250 when the hoist is in use. The boom 260 is substantially horizontal in both operational and stowed states in preferred embodiments of this invention.

The terms “boom latch” and “boom lock” interchangeably refer herein to a latch 220 that is hinged coupled at the distal end 221 to the distal region 261 of the boom 260 and has at least one locking surface at its distal end 222 that engages a locking surface at the proximal end 211 of the stanchion 210 as this invention is unfolded into an operable state.

The term “mounting base” refers to any structure that is capable of supporting the crane assembly and load during use and has an insertion opening 770 that can be adaptively coupled to the pivot shaft 240. 710, 810, 910, 1010, 1110 are exemplary embodiments of mounting bases that are usable with for the present invention.

The term “insert adapter” refers herein to a substantially vertical cylindrical opening 770 adaptable to mate with the pivot shaft during recoverable installation of the hoist to the mounting base 710.

Preferred embodiments of the present invention employ additional latches 1210, 1310, 1610, jigs 1510, boom extenders 1410, actuators 1810, and winches 1630, 1710 to improve performance or utility of the present invention for specific applications.

The term “base latch” refers herein to a latching mechanism 1210 that engages and secures the proximal end 211 of the stanchion 210 to any surface on the mounting base as the present invention is folded into a stowed state.

The term “stanchion latch” refers herein to a latching mechanism 1310 that engages and secures the stanchion 210 to the boom 260 as the present invention is folded into a stowed state.

The term “boom extender” refers herein to an insert 1410 that is preferably attached to a load coupler and can be inserted into the boom 260 to collectively extend the reach of the boom 260. The adaptively coupled position of boom extender 1410 inside the boom 260 is adjustable in preferred embodiments.

The term “kick-stand jig” refers herein to a hinge mounted jig 1510 that operates substantially in the same manner as a kick-stand. The jig relies on a spring 1520 or other means of mechanical tension to force the jig to snap into operable and stowed states. The top of the jig includes an upper surface that engages and locks to a lower surface on the mounting base when the jig is unfolded into an operable state.

The term “rotational swing lock” refers herein to a rotational latch 1620 at the base of the pivot hinge that is capable of adaptively coupling with a plurality of surfaces 1621 at the distal end 211 of the stanchion 210 or the lower end 235 of the pivot hinge 230 to control pivotal rotation.

The term “tilt lock” refers herein to a releasable latch 1610 at the distal end 211 of the stanchion 210 that engages a locking surface 233 on the pivot hinge 230 to prevent the stanchion 260 from folding backward into a stowed state while it is unfolded into an operative state.

### Preferred Embodiments

In preferred embodiments, the pivoting hinge 230 serves as a supporting stop for the stanchion 210 as it is unfolded, the boom lock 220 drops and locks into place as the lifting arm 260 is raised into operating position, and safety latches 1210, 1310 engage the stanchion 210 and boom 260 when it is folded back into storage. Preferred embodiments position the pivoting hinge 230 at a low elevation on the structure to give a folded embodiment of the present invention a low profile.

Preferred embodiments rely on two essential features to improve lifting capacity and operational safety; namely a pivot hinge 230 that adaptively couples to the stanchion 210, and a pivot shaft 240 that is rotationally coupled through the pivot hinge 230. The pivot hinge 230 and pivot shaft 240 mate by passing the pivot shaft 240 through a substantially vertical cylindrical opening in the pivot hinge 230. In preferred embodiments the vertical height of the cylindrical opening on the pivot hinge 230 is substantial enough to distribute force along the shaft 240.

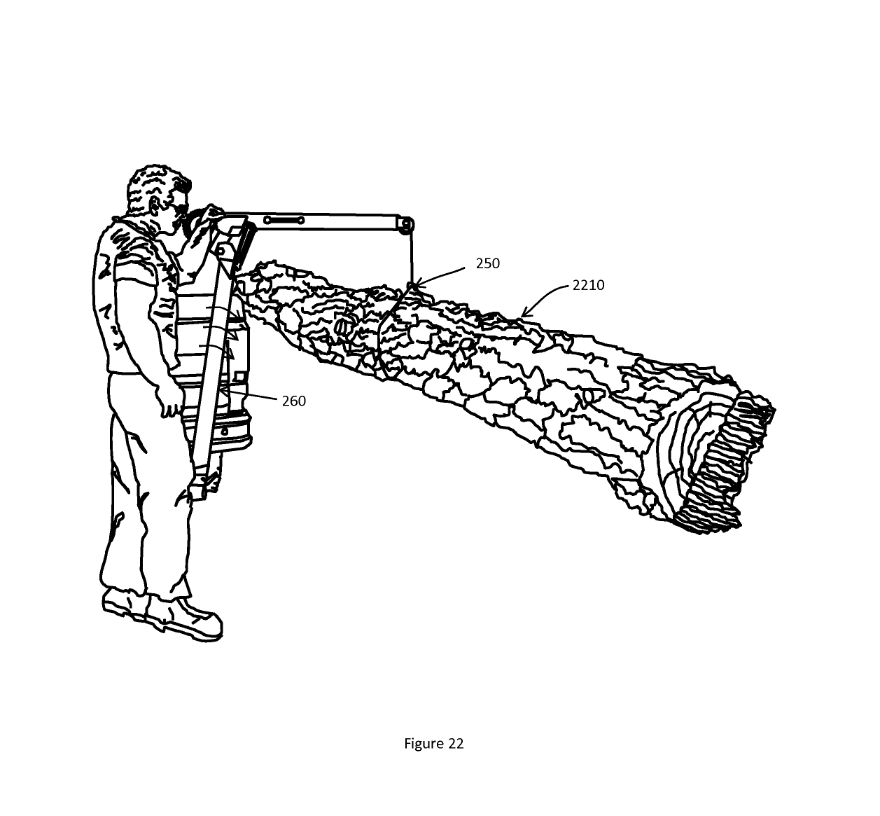

In preferred embodiments, the pivot shaft 240 is designed to be a weak point in the apparatus that slowly bends to lower a load that is heavy enough to induce failure in the crane. The sample illustration in FIG. 22 shows how a properly designed pivot shaft allows the stanchion 260 to lean over and lower the load as an oversized log 2210 induces failure in the hoist.

Assembly of the essential components comprises the steps of rotationally coupling the pivot hinge 230 and pivot shaft 240 as shown in FIG. 6, hinge coupling the pivot hinge 230 to the distal end 211 of the stanchion 210 as shown in FIG. 3, hinge coupling the distal end 261 of the boom to the proximal end 212 of the stanchion as illustrated in FIG. 13, hinge coupling the proximal end 222 of the boom lock 220 to the distal region 261 of the boom 260 as shown in FIG. 16, and adaptively attaching a load coupler 250 to the proximal end 262 of the boom 260 as shown with an optional boom extender 1410 in FIG. 14. The above assembly is then adaptively coupled to an insert 770. The exemplary insert adapters 770 shown in the Figures are for illustrative purposes and are not intended to limit the scope of this invention.

A preferred assembly of the pivot shaft 240 and pivot hinge 230 is shown in FIG. 6. The pivot shaft 240 preferably has a cold-head at the proximal end 241 to prevent the pivot hinge 230 from slipping off. Slip rings, pins, threaded adapters and the like affixed to the proximal end 241 of the pivot shaft 240 will also prevent the pivot hinge 230 from slipping off. In preferred embodiments the pivot hinge 230 spans a distance along the pivot shaft 240 that is greater than or equal to the diameter of the pivot shaft 240. A pivot hinge 230 may span a shorter distance along the pivot shaft 230 for embodiments of this invention that are intended for lighter loads. Preferred embodiments include a mechanical means to couple the pivot shaft 240 to a mounting base 770 at the distal end 242 of the pivot shaft. The exemplary embodiments shown in the figures use a fastening pin.

Preferred embodiments of the pivot hinge 230 have a substantially horizontal upper surface 234 that engages the distal end 211 of the stanchion as it is unfolded into a locked operating position. The upper surface 234 of the pivot hinge is preferably angled slightly downward toward the proximal end 232 of the pivot hinge 230. The proximal end 232 of the pivot hinge 230 preferably has a substantially horizontal locking surface 233 that engages a tilt lock 1610 to prevent unintentional folding of the stanchion 210 when in use.

The pivot hinge 230 and stanchion 210 are preferably hinge coupled in a manner that maximizes surface contact between the distal end 211 of the stanchion 210 and the upper surface 231 of the pivot hinge 230. An exemplary embodiment of the pivot hinge 230 and stanchion 210 assembly is shown in FIG. 3.

Preferred embodiments of the boom lock 220 include a hinge coupling point at the proximal end 222 and a locking surface at the distal end 221 that engages a locking surface at the proximal end 211 of the stanchion 210. Bends and gussets along the edges of the boom lock 220 are preferably used to enhance strength.

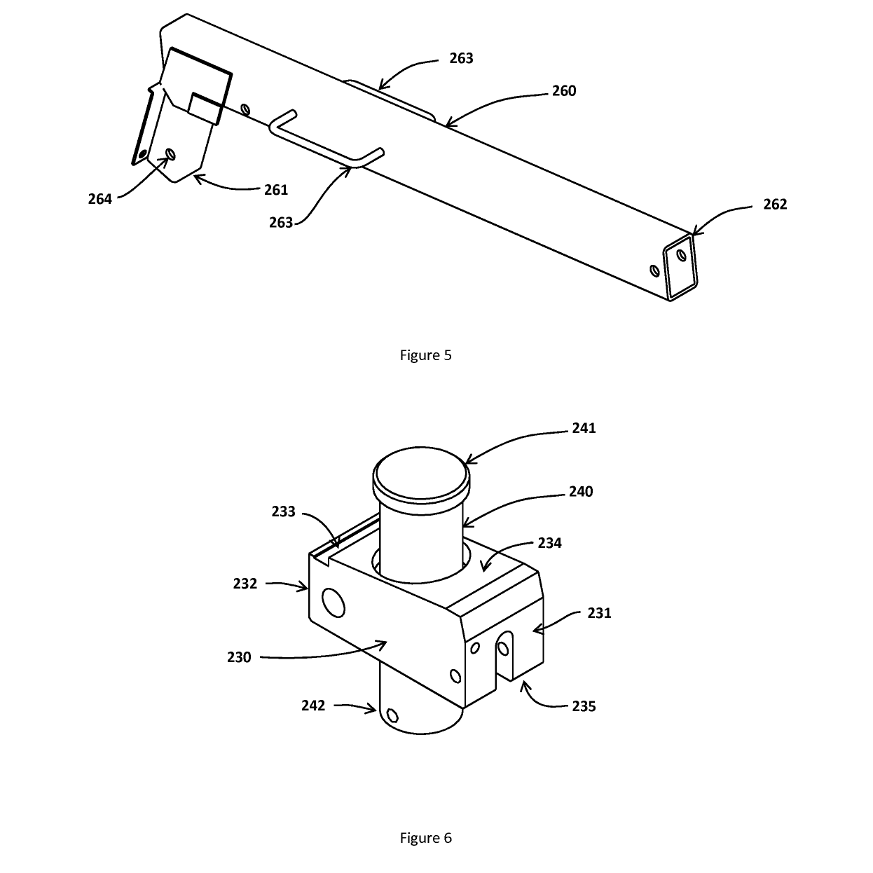

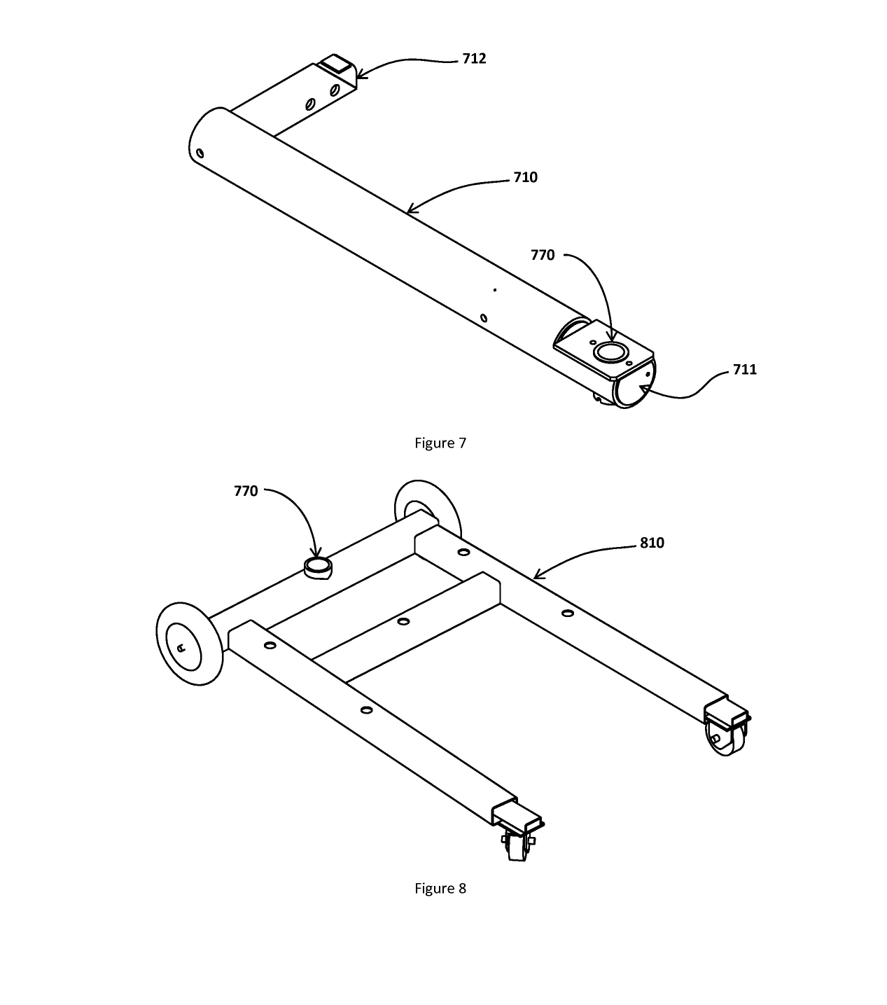

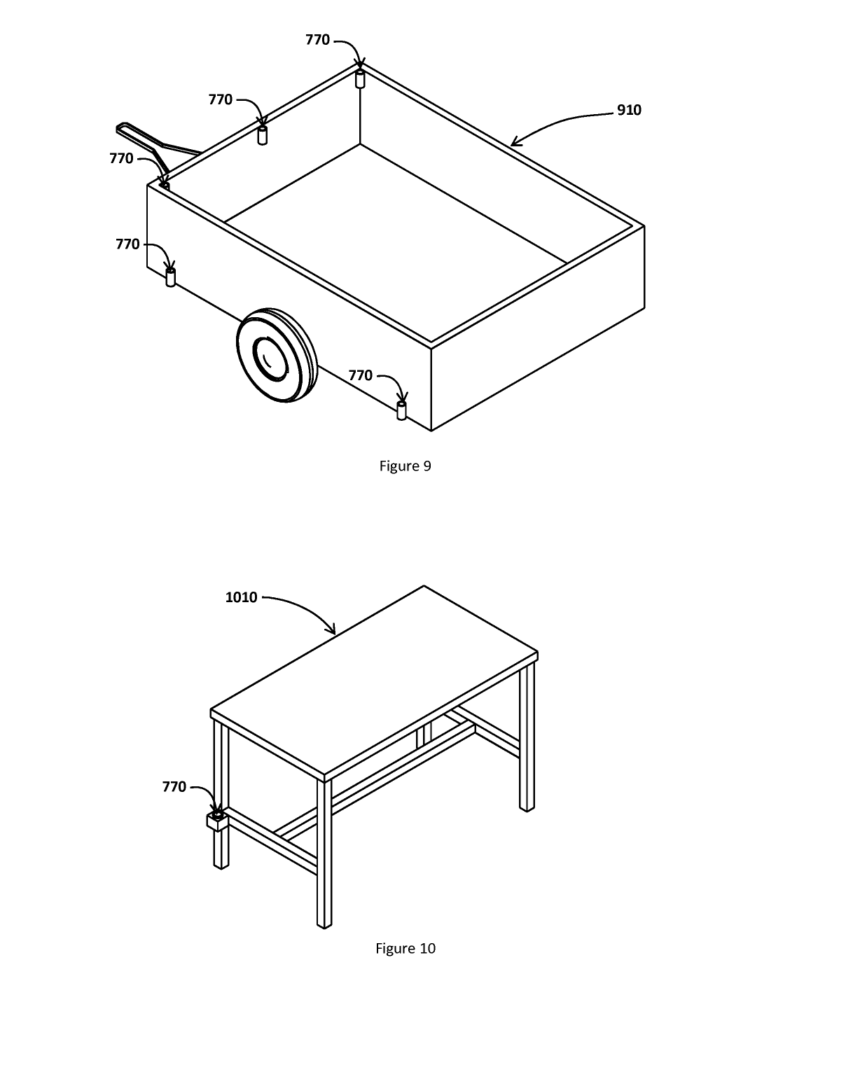

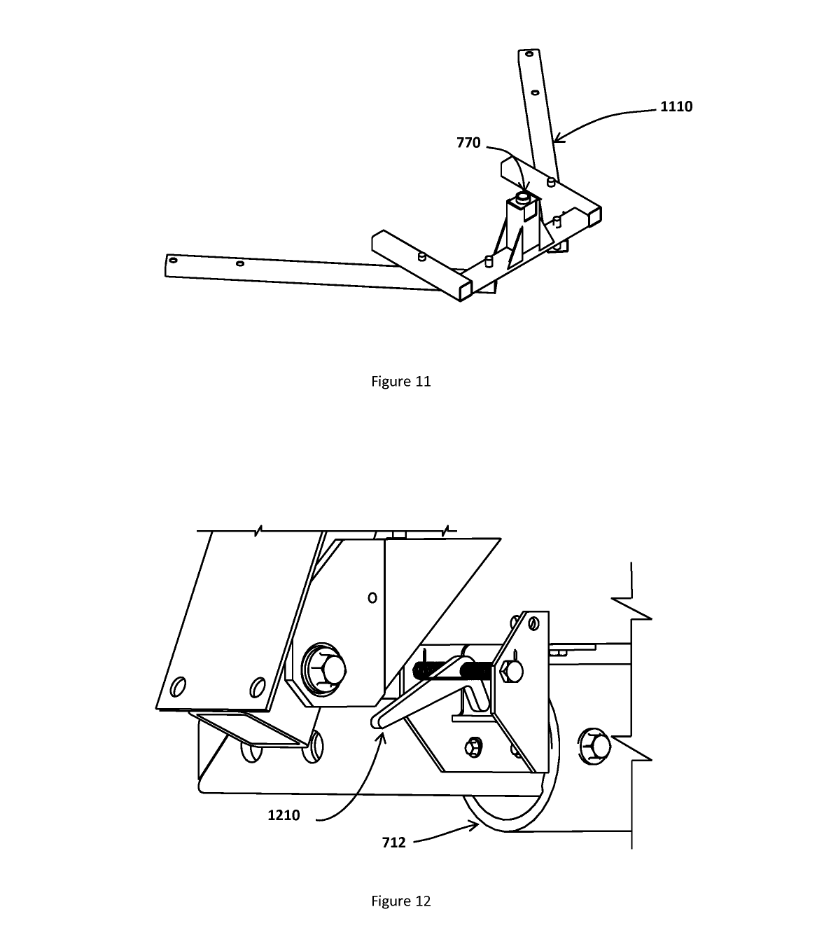

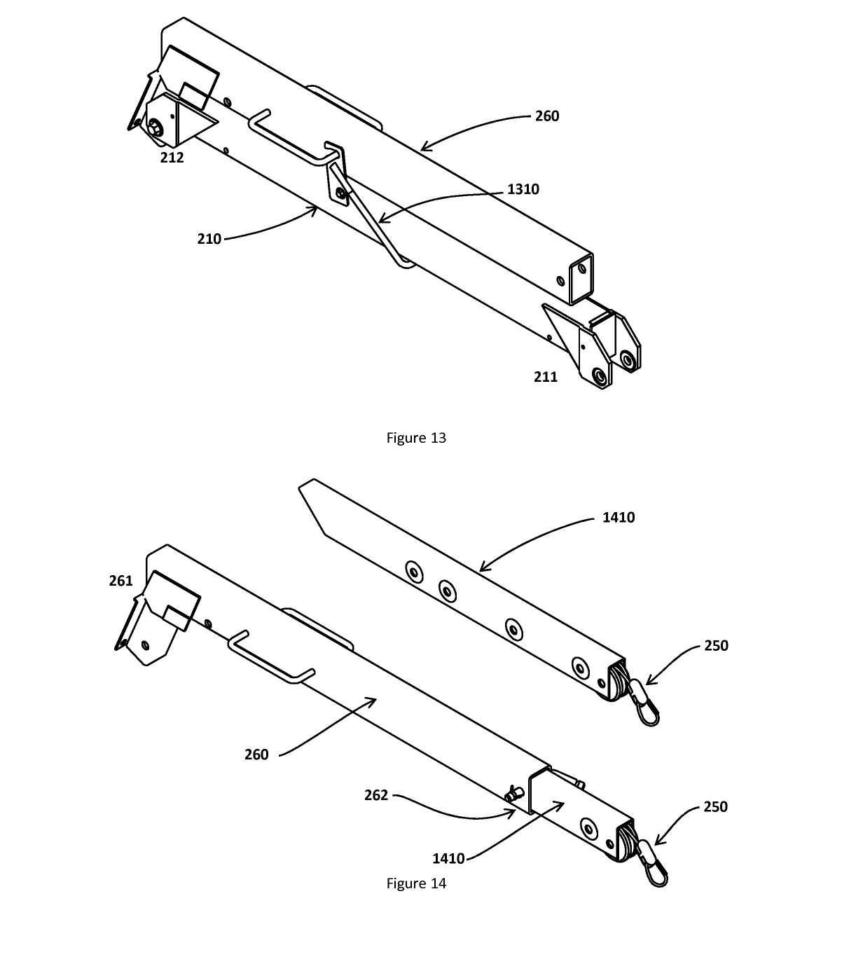

Preferred boom 260 embodiments include a hinge coupling point 264 that is offset slightly from the center of the distal end 261 as shown in FIG. 5. The boom 260 embodiment shown in FIG. 5 includes handles 263 for transporting and operating the hoist and for coupling to the stanchion latch 1310 shown in FIG. 13.

Preferred base latch embodiments 1210 include a spring affixed to the latch to ensure proper engagement to a mating surface 712 on the mounting base 710.

Embodiments of the present invention are adaptively attachable to any plurality of mounting bases. Exemplary embodiments of mounting bases include a vehicle receiver hitch mounting base 710, a base to a portable cart or portable engine hoist 810, mounting base attachments for trailers and portable carts 910, adaptable inserts for tables or working benches 1010, and adaptable inserts for roof, floor, and wall mounts 1110.

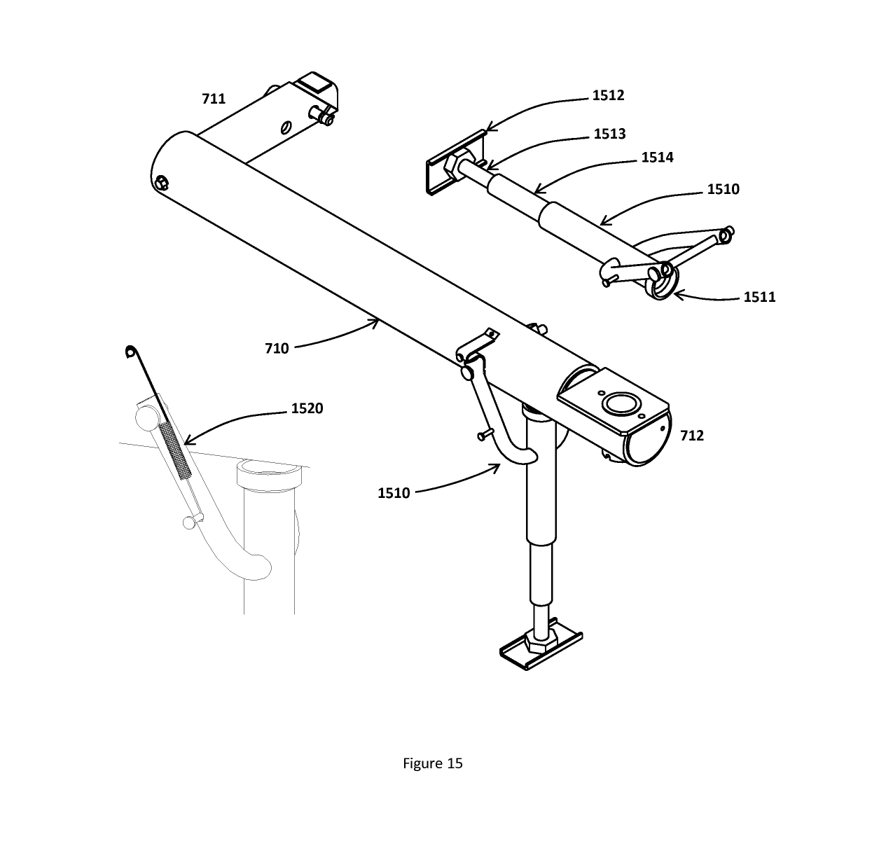

The mounting base embodiment 710 shown in FIG. 15 is well suited for use with vehicles that have a receiver hitch. The mounting base 710 includes a substantially horizontal tube with an adapter at the distal end 711 intended for recoverable engagement into a vehicle receiver hitch and an insert adapter 770 at the proximal end 712 that adaptively couples to the pivot shaft 240.

Preferred embodiments of the receiver hitch adaptable mounting base 710 include a kick-stand style jig 1510 at the proximal region 712 of the mounting base 710. The kickstand jig includes a hinge coupling point that is offset from the distal end 1511, a plurality of segments 1513, 1514 that provide height adjustment, a base at the proximal end 1512, and a spring 1520 or other mechanical means to force the kickstand jig to snap into operable and stowed states as it is folded and unfolded.

Accessories such as hand-brake winches 1630, electric winches 1710, and actuators 1810 are interchangeably attachable to preferred embodiments of the present invention.

### Preferred Methods

Essential steps of the preferred method include disengaging latches and locks and unfolding the apparatus from a stowed state, ensuring that all latches and locks that lock the hoist into an operative state are engaged before use, coupling the apparatus to a load, raising the load, optionally engaging a rotational latch to control pivotal rotation, swinging the load into a desired position, lowering the load, uncoupling the hoist from the load, swinging the hoist over the mounting base, and disengaging all latches and locks that lock the hoist into an operative state, folding the apparatus back into a stowed state, and ensuring that all latches and locks that lock the apparatus into a stowed state are engaged.

It is optimal to use this invention on a level surface to minimize the threat of damage to the hoist, host vehicle, or payload and further to impede the threat injury to the hoist operator. If this invention is used on an uneven surface, a preferred method is to level the hoist by making height adjustments to the kickstand jig 1510. If a load must be lifted from an uneven or un-level surface, a preferred method to prevent damage or personal injury is to engage the rotational swing latch until the load can be transported to a level surface.

### Exemplary Uses of Preferred Embodiments

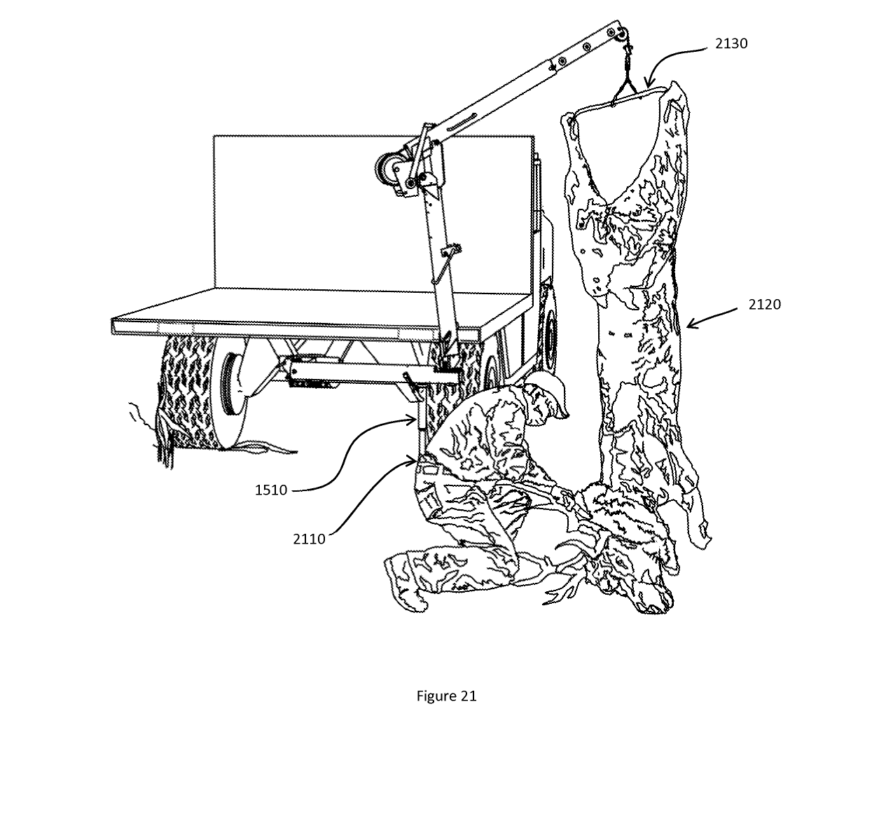

The present invention is well suited for most lifting applications. Spreaders 1920 should be used when lifting large objects such as lawn mowers, equipment, or all-terrain vehicles 1910. The kickstand style jig should also be deployed when lifting heavy loads; particularly those that approach the limit of the device that supports the mounting base. More than one lifting point should be used on the load as shown in FIG. 20 when using the present invention to lift large objects that may be difficult to control.

The present invention is well suited for hunting applications and can be used to winch in large game and to subsequently elevate the animal for processing. The exemplary application in FIG. 21 shows a bull elk that has been hoisted so that it can be processed in the field by a hunter. The lifting capacity of the embodiment shown in the figure exceeds the weight of the animal. This embodiment enables an individual hunter to process and load the large animal into a vehicle without assistance.

If the present invention is used to lift logs or other durable items, it may be beneficial to simply wrap the lifting cable of the hoist around the load and use the load coupling hook to form a noose with the cable as shown in FIG. 22. Caution should be exercised to ensure that the load, the hoist, and the host vehicle are capable of supporting the load.

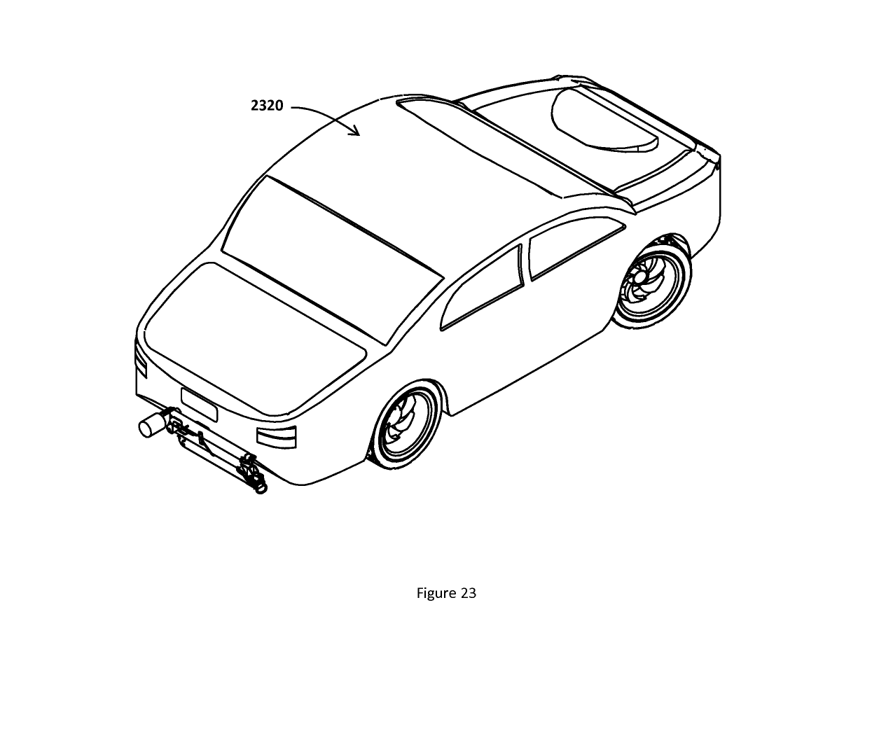

The present invention is well suited for lifting powered mobility chairs and other light loads when affixed to the rear of a vehicle as shown in FIG. 23. Caution should be exercised to ensure that the load, the hoist, and the host vehicle are capable of supporting the load.

It is understood that the above embodiments and applications are merely illustrative of the possible specific applications which may represent principles of the present invention. Other embodiments may readily be devised in accordance with the principals herein by those skilled in the art without departing from the scope and spirit of this invention.

1. A crane apparatus that engages an insert adapter, that can be folded in and out of operable states without disassembly, is capable of remaining fully assembled in said insert adapter while in tow that further comprises
a pivot hinge comprising a substantially flat upper surface adapted to engage the distal end of a stanchion of said crane apparatus causing said stanchion to lock into a substantially vertical operative state as said crane apparatus is unfolded, a substantially vertical cylindrical opening adapted for pivotable attachment to a substantially vertical pivot shaft, and a substantially horizontal opening adapted for hinge coupled attachment to the distal region of a stanchion,
a stanchion comprising a substantially horizontal hinge coupling point at a distal end adapted for hinge coupled attachment to said pivot hinge, a substantially horizontal hinge coupling point on the proximal end adapted for hinge coupled attachment to a lifting boom, a substantially flat surface at said proximal end adapted to engage upper surface of said pivot hinge as said crane apparatus is unfolded into an operable state, and a locking surface at the proximal end adapted to engage a boom lock as said crane apparatus is unfolded into an operable state,
a boom lock having a substantially horizontal hinge coupling point at the proximal end adapted for hinge coupled attachment to a lifting boom and a lock engagement point at the distal end adapted to engage said locking surface on the proximal end of said stanchion as said crane apparatus is unfolded into an operable state,
a boom having a substantially horizontal hinge coupling point at the distal end adapted for hinge coupled attachment to the proximal end of said boom lock, a substantially horizontal hinge coupling point at the distal end adapted for hinge coupled attachment to the proximal end of said stanchion, and an attachment at the proximal end adaptable to engage a lifting coupler,
a pivot shaft inserted through said substantially vertical cylindrical opening of said pivot hinge, said pivot shaft adapted at the distal end for attachment to a mounting base.

2. Said mounting base of claim 1 that further comprises a substantially horizontal structure having a distal end with a substantially vertical cylindrical opening adapted for attachment to the distal end of said pivot shaft and a proximal end having an insert physically adapted for recoverable insertion into a vehicle receiver hitch.

3. Said mounting base of claim 1 that further comprises a portable cart having a substantially vertical cylindrical opening adapted for attachment to said pivot shaft.

4. Said mounting base of claim 1 that further comprises an attachment adaptable for mounting to a portable structure with said mounting base having a substantially vertically oriented cylindrical opening adapted for attachment to said pivot shaft.

5. Said mounting base of claim 1 that further comprises an attachment adaptable for mounting to a fixed structure with said mounting base having a substantially vertically oriented cylindrical opening adapted for attachment to said pivot shaft.

6. Said mounting base of crane apparatus of claim 1 that further comprises an attachment adapted to mount to a vehicle with mounting base having a substantially vertical oriented cylindrical opening adapted for attachment to said pivot shaft.

7. Said crane apparatus of claim 1 that further comprises a latching mechanism attached to said stanchion adaptable to engage said mounting base to cause said crane apparatus to lock into a stowed position when folded.

8. A crane apparatus of claim 1 that further comprises a latching mechanism attached to said stanchion adaptable to engage said boom to cause said boom to lock into a stowed position when folded.

9. A lifting coupler of claim 1 that further comprises an insert adapted for adjustable position insertion into the proximal end of said boom for the purpose of forming an extendable boom.

10. A crane apparatus of claim 1 that further comprises a winch and a lifting line with an end adapted to lift objects.

11. A crane apparatus of claim 1 that further comprises a plurality of actuators adapted to fold and unfold said stanchion relative to said mounting base.

12. A crane apparatus of claim 1 that further comprises a plurality of actuators adapted to raise and lower said boom relative to said stanchion.

13. A crane apparatus of claim 1 that further comprises a lifting line attached to the boom with an end adapted to lift objects.

14. A crane apparatus of claim 1 that further comprises an attachment at the distal end of the boom adapted for lifting objects.

15. A kickstand style jig apparatus for a portable hoist that comprises in combination
an upper portion having a substantially horizontal hinge coupling point at the distal end adapted for hinge coupled attachment to a mounting base of said portable hoist and a surface at the distal end adapted to engage a trapping surface of said mounting base causing the kickstand style jig apparatus to lock into an operable state as it is unfolded,
a lower portion having a base attached substantially perpendicular to the proximal end and a plurality of segments at the distal end adapted for vertically adjustable position attachment to the proximal end of said upper portion,
a mechanical means such as a spring to induce pulling tension between a fixed point above the hinged coupling attachment to said mounting base and a fixed point of the kickstand style jig to force the kickstand style jig to remain in place when folded into stowed and operative states.

16. A method of operating a portable hoist which may be unfolded and locked into an operable state and refolded and locked into a stowed state without the need for assembly or pins; said method comprising the steps of
unfolding a stanchion and boom assembly away from a base mount until said base of said stanchion comes to rest against the upper surface of a pivot hinge,
unfolding said boom assembly away from said stanchion until a boom lock drops into place and causes said boom assembly to lock into an operable state,
connecting a component of said hoist that is attachable to a load to a secure point on said load,
using said hoist to cause said attachable load coupling adaptor to raise and lower said load,
rotating said stanchion, boom assembly, and load to position said load,
releasing said attachable load coupling adaptor from load,
releasing said boom lock from locked position and lowering said boom out of operative state until said boom rests against said stanchion,
folding said stanchion and boom assembly away from operative state against pivot hinge until said stanchion and boom assembly achieves a stowed state.

17. A method of claim 16 that further comprises releasing a plurality of latches to unlock said hoist while unfolding said stanchion and boom assemblies into an operative state.

18. A method of claim 16 that further comprises engaging a plurality of latches to lock said hoist while folding said stanchion and boom assemblies into a stowed state.

19. A method of claim 16 that further comprises adjusting the position of a plurality of attachments adapted to allow the boom to extend in reach.
